(19) United States
(12) Patent Application Publication
(10) Pub. No.: US 2020/0184373 A1
(43) Pub. Date: Jun. 11, 2020

(54) Recurrent Gaussian Mixture Model For Sensor State Estimation In Condition Monitoring

(71) Applicant: Siemens Aktiengesellschaft, Munich (DE)

(72) Inventors: Chao Yuan, Plainsboro, NJ (US); Amit Chakraborty, East Windsor, NJ (US)

(21) Appl. No.: 16/638,778

(22) PCT Filed: Aug. 30, 2017
(86) PCT No.: PCT/US2017/049242

§ 371 Date: Feb. 13, 2020

(51) Int. Cl. G06N 20/00; G06N 7/00; G05B 23/02

(52) U.S. Cl. CPC G06N 20/00; G05B 23/0254; G06N 7/005

(57) ABSTRACT

A computer-implemented method for monitoring a system includes training a recurrent Gaussian mixture model to model a probability distribution for each sensor of the system based on a set of training data. The recurrent Gaussian mixture model applies a Gaussian process to each sensor dimension to estimate current sensor values based on previous sensor values. Measured sensor data is received from the sensors of the system and an expectation maximization technique is performed to determine an expected value for a particular sensor based on the recurrent Gaussian mixture model and the measured sensor data. A measured sensor value is identified for the particular sensor in the measured sensor data. If the measured sensor value and the expected sensor value deviate by more than a predetermined amount, a fault detection alarm is generated to indicate that the system is not operating within a normal operating range.

### TECHNICAL FIELD

The present disclosure relates generally to the use of a recurrent Gaussian mixture model for sensor state estimation in condition monitoring. The techniques described herein may be applied, for example, to perform condition monitoring of machines in an industrial automation system.

### BACKGROUND

Condition monitoring relates to the observation and analysis of one or more sensors that sense key parameters of machinery. By closely observing the sensor data, a potential failure or inefficiency may be detected and remedial action may be taken, often before a major system failure occurs. Effective condition monitoring may allow for increased uptime, reduced costs associated with failures, and a decreased need for prophylactic replacement of machine components.

Condition monitoring may be applied to a wide variety of industrial machinery such as capital equipment, factories and power plants; however, condition monitoring may also be applied to other mechanical equipment such as automobiles and non-mechanical equipment such as computers. In fact, principals of condition monitoring may be applied more generally to any system or organization. For example, principals of condition monitoring may be used to monitor the vital signs of a patient to detect potential health problems. As another example, principals of condition monitoring may be applied to monitor performance and/or economic indicators to detect potential problems with a corporation or an economy.

In condition monitoring, one or more sensors may be used. Examples of commonly used sensors include vibration sensors for analyzing a level of vibration and/or the frequency spectrum of vibration. Other examples of sensors include temperature sensors, pressure sensors, spectrographic oil analysis, ultrasound, and image recognition devices. A sensor may be a physical sensory device that may be mounted on or near a monitored machine component or a sensor may more generally refer to a source of data.

Sensor state estimation is one critical step in condition monitoring: based on the observed sensor values y, the values x that sensors should have if the machine is operating normally may be estimated. If the residual r=y−x for certain sensors is too large, this may indicate failures. A typical sensor state estimation algorithm needs to address two problems. The first one is how to model the normal operating range, or the probabilistic distribution of normal data P(x). The second problem is how to map to x from a given observation y, or compute the probability of x conditioned on y.

One conventional technique is to use a Gaussian mixture model (GMM) which can be used to model P(x). FIG. 1A shows the corresponding graphical model, where s indicates the component indicator of the mixture model. Component corresponds to operating mode (i.e., state) of a machine. In this approach, even if sensor signals are time series (indexed by subscript t), signals at different times are treated independently. For this reason, there is no connection between variables between t−1 and t. A GMM can be expressed by

P(sₜ=i)=pᵢ, (1)

P(xₜ|sₜ=i)=N(xₜ|mᵢ,Cᵢ) (2)

where i=1, 2, . . . , K (the total number of components in a GMM). pᵢ is the probability of k-th component. Given component sᵢ, x has a Gaussian distribution with mean mᵢ and covariance Cᵢ. The observed signal y is modeled by another Gaussian distribution

P(yₜ|xₜ)=N(yₜ|xₜ,θ), (3)

with mean xₜ and diagonal covariance θ. θ limits the magnitude of deviation. For normal values of y, θ is small, thus y is restricted to be close to x. For faulty values of y (i.e., those outside of the normal range), θ is large to allow large deviation of y from x. During training, an Expectation-Maximization (EM) algorithm is used to estimate parameters pᵢ, mᵢ and Cᵢ, where i=1, 2, . . . , K. During monitoring, another EM algorithm is used to compute P(xₜ|yₜ) and estimate θ simultaneously.

The main drawback of GMM is the ignorance of temporal dependency between sensor signals. This may be overcome by stationary switching autoregressive model (SSAR). FIG. 1B shows the graphic model of an SSAR. Specifically, component indicator sₜ now follows a Markov chain and has a transition probability from its previous component S_{t-I}.

P(sₜ=j|sₜ₋₁=i)=Zᵢⱼ, (4.1)

P(s₁=i)=pᵢ. (4.2)

Z is a K by K transition probability matrix. The first component S_{I} is sampled independently like GMM, because there is no previous component. Normal sensor signal xₜ also depends on previous signal xₜ₋₁

$$P ( {x}_{t} \vert {x}_{t - 1} , {s}_{t} = j , {s}_{t - 1} = i ) = \{ \begin{matrix}N ( {x}_{t} \vert {A}_{j} ( {x}_{t - 1} - {m}_{j} ) + {m}_{j} , {Q}_{j} ) , & if i = j \\ N ( {x}_{t} \vert {m}_{j} , {C}_{j} ) , & if i \neq j\end{matrix} . \qquad ( 5 )$$

Equation (5) is similar to Equation (4.1) and (4.2), however, the former is more complicated because it makes predictions regarding continuous time series data. Equation (5) uses a Gaussian distribution (as denoted by the N in the equation).

In Equation (5), if signals stay in the same component (i=j), the sensor value of the current time xₜ follows a vector autoregressive model. This model is autoregressive because xₜ is predicted based on its past values xₜ₋₁. Because this model is linear, the relationship between xₜ₋₁ and xₜ is represented by matrix multiplication (with Aⱼ). Qⱼ denotes the covariance of error that cannot be described by the model. If signals switch from component i to a different j, xₜ can be generated independently from xₜ₋₁ like the GMM case. This is because under different operating modes, signals can be quite different. In SSAR, signals at different time are now correlated due to component transition in Equation (4) and autoregression in Equation (5). Observed signals y are modeled in the same way using Equation (3) as in GMM.

Even if SSAR takes temporal dependency into consideration, only linear dependency is used. However, for complex machines, temporal dependency is usually nonlinear. Recurrent neural networks (RNN) may be applied to address the non-linearity. The idea of RNN is to model the temporal dependency by a neural network that is able to handle nonlinearity. However, RNN typically assumes smooth dependency between adjacent signals and cannot handle the component switching case (as can be done by GMM and SSAR).

### SUMMARY

Embodiments of the present invention address and overcome one or more of the above shortcomings and drawbacks, by providing methods, systems, and apparatuses related to the use of recurrent Gaussian mixture model for sensor state estimation in condition monitoring.

According to some embodiments, a computer-implemented method for monitoring a system includes training a recurrent Gaussian mixture model to model a probability distribution for each sensor of the system from among a plurality of sensors of the system based on a set of training data. In one embodiment, the training data is recorded from the sensors during a period of fault-free operation of the system. The recurrent Gaussian mixture model applies a Gaussian process to each sensor dimension to estimate current sensor values based on previous sensor values. Measured sensor data is received from the sensors of the system and an expectation-maximization technique is performed to determine an expected value for a particular sensor based on the recurrent Gaussian mixture model and the measured sensor data. A measured sensor value is identified for the particular sensor in the measured sensor data. If the measured sensor value and the expected sensor value deviate by more than a predetermined amount, a fault detection alarm is generated to indicate that the system is not operating within a normal operating range.

Various enhancements, refinements, and other modifications may be made to the aforementioned method in different embodiments. For example, in some embodiments, the recurrent Gaussian mixture model utilizes a plurality of mixture components and each component follows a Markov chain from a previous corresponding component. In some embodiments, each mixture component corresponds to one of a plurality of machines states. These states may comprise, for example, a sleeping state, a stand-by state, and a running state. This fault detection alarm may comprise, for example, an audible alarm generated by a speaker associated with the system. In one embodiment, the fault detection alarm comprises a visual alarm presented on a display associated with the system.

In some embodiments, the recurrent Gaussian mixture model in the aforementioned method is trained by first training a stationary switching autoregressive model to obtain initial estimates for parameters comprising (a) a component probability; (b) a mean value for a Gaussian distribution of expected sensor values; (c) covariance for the Gaussian distribution of expected sensor values; and (d) a component transition probability matrix. An iterative re-estimation process is then performed until convergence of one or more of the parameters. This re-estimation process includes assigning each sensor value in the set of training data to one of the plurality of components in the component transition probability matrix based on the component probability. In one embodiment, the sensor value is assigned to the one of the plurality of components in the component transition matrix by making a hard decision. For each component, the sensor values assigned to the component are used to train the Gaussian process corresponding to the component. Additionally, for each component, an expectation-maximization technique is performed to re-estimate the parameters for the component based on the Gaussian process corresponding to the component.

Various techniques may be used parallelizing the aforementioned methods to perform computations in a faster manner. Such parallelization may be performed using a system comprising the system sensors and a plurality of processors configured to perform at least a portion of the activities discussed above. For example, in one embodiment, the plurality of processors is used to train the Gaussian process for multiple components in parallel. In another embodiment, the processors are used to perform the expectation-maximization technique for multiple components in parallel.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1A shows a visualization of a Gaussian mixture model (GMM) which can be used to model P(x);

FIG. 1B shows a visualization of a stationary switching autoregressive model;

FIG. 1C shows a visualization of a recurrent Gaussian mixture model, according to some embodiments;

FIG. 2 illustrates a method for training a recurrent Gaussian mixture model, according to some embodiments;

FIG. 3 illustrates a method for performing machine condition monitoring using sensor data, according to some embodiments of the present invention; and

FIG. 4 provides an example of a parallel processing memory architecture that may be utilized for condition monitoring or training the models discussed herein, according to some embodiments of the present invention.

### DETAILED DESCRIPTION

Systems, methods, and apparatuses are described herein which relate generally to the use of recurrent Gaussian mixture model (RGMM) for sensor state estimation in condition monitoring. More specifically, a RGMM is used to address the sensor state estimation problem. Inspired by the RNN, the linear autoregressive part in Equation (5) is replaced with a nonlinear regression function while keeping the other parts of the model intact. The term “recurrent,” as used herein, means that the past is reused as part of a new model. Without recurrence, time dependency is ignored. Therefore, the RGMM can not only describe nonlinear temporal dependency, but also model component switching.

The key ingredient of recurrent Gaussian mixture model (RGMM) is to introduce nonlinearity by replacing Equation (5) by

$$P ( {x}_{t} \vert {x}_{t - 1} , {s}_{t} = j , {s}_{t - 1} = i ) = \{ \begin{matrix}{\prod }_{d = 1}^{D} N ( {x}_{t , d} \vert f ( {x}_{t - 1} , w ) , {σ}_{d}^{2} ) , & if i = j \\ N ( {x}_{t} \vert {m}_{j} , {C}_{j} ) , & if i \neq j\end{matrix} . \qquad ( 6 )$$

In Equation (6), ƒ(x,w) can be any regression function with w as its parameter. ƒ may utilize various kernels, neurons, etc. that make it non-linear. The simplest form is the autoregressive function used in SSAR. The techniques described herein use Gaussian process rather than an autoregressive function between xₜ₋₁ and xₜ.

As is generally understood in the art, a Gaussian process is a collection of random variables, where any finite subset of the variables follows a multivariate Gaussian distribution. Suppose there are D sensors. The Gaussian process is applied to each sensor dimension. In other words, the d-th sensor value x_{t,d} at current time t is regressed on all previous sensor values xₜ₋₁. σ_{d} is the standard deviation for the d-th regression function. It is assumed that given previous signals xₜ₋₁, the values of x_{t,d} are independent of each other. Additional information on Gaussian processes is described in C. E. Rasmussen and C. K. I. Williams, “Gaussian Processes for Machine Learning”, The MIT Press, 2006. Because the Gaussian process is powerful at fitting nonlinear data, the techniques described herein do not require a different Gaussian process for each different component. However, in some embodiments, different processes may be used for each component. The RGMM is complete after integrating Equations (3), (4.1) and (4.2) with Equation (6).

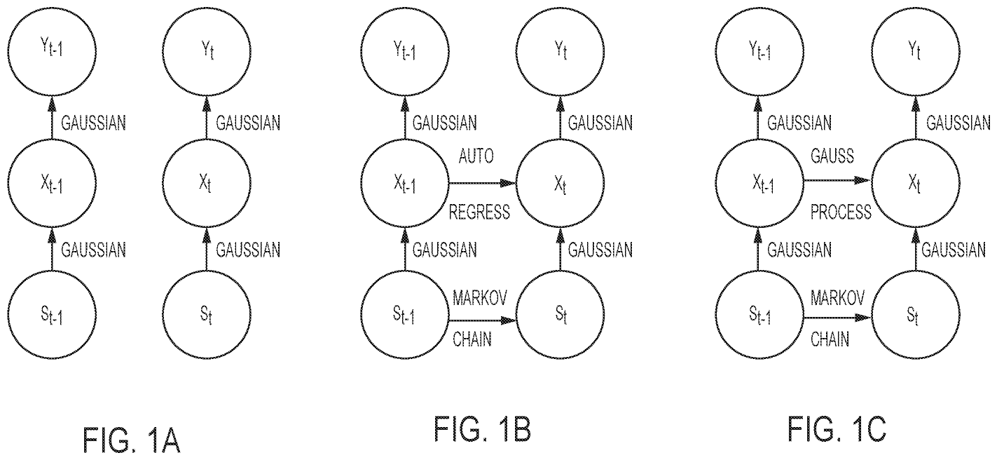

FIG. 1C shows the RGMM that provides an intuitive explanation of the mathematics behind the process. For a machine, s can be a number indicating the state. So, for example, s=2 may be in running mode, s=1 may be in standby mode, and s=0 may be in sleep mode of a particular machine. The values of xₜ₋₁ to xₜ are the continuous time series, which is never measured and yₜ₋₁ to yₜ are the values that are measured. Each arrow indicates information flow. Where an arrow exists between the left-hand side and the right-hand side (i.e., sₜ₋₁ to sₜ and xₜ₋₁ to xₜ), this means the value of the left-hand-side may be used to predict the value on the right-hand side. The values of x are the sensor values that may include measurements of, for example, gas flow, temperature, etc. In general, any time-series sensor data may be included in x.

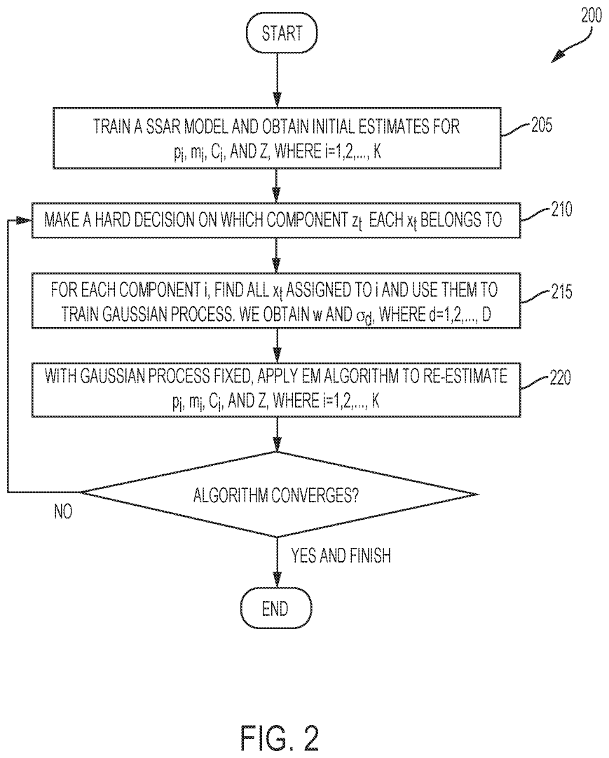

FIG. 2 illustrates a process 200 for training a RGMM, according to some embodiments. The objective of training is to learn parameters pᵢ, mᵢ, Cᵢ, Z, w and σ_{d} (where i=1, 2, . . . , K and d=1, 2, . . . , D) from normal sensor time series. The EM algorithm is adopted. Starting at step 205 a SSAR model is trained and initial estimates for pᵢ, mᵢ, Cᵢ, and Z are obtained. At step 210, a hard decision is made on which component zₜ each xₜ belongs to. That is, based on the current observation, we want to predict the current state of the machine. As is currently understood in the art, a “soft” decision is one in which everything has a probability. For example, there may be a 30% probability that the machine is in a stand-by state, a 30% chance that the machine is in a sleeping state, and a 40% chance that the machine is in a running state. For a “soft” decision, each of these values is consider. Conversely, a “hard” decision only looks at the most likely values and the other probabilities are ruled out. So, continuing with the above example, the state will be assumed to be running because that is most likely. For implementation purposes, this means that the probability that the state is running will be “1,” while the probability of other states will be “0.” In some embodiments, the EM algorithm may be used to determine the hard decision.

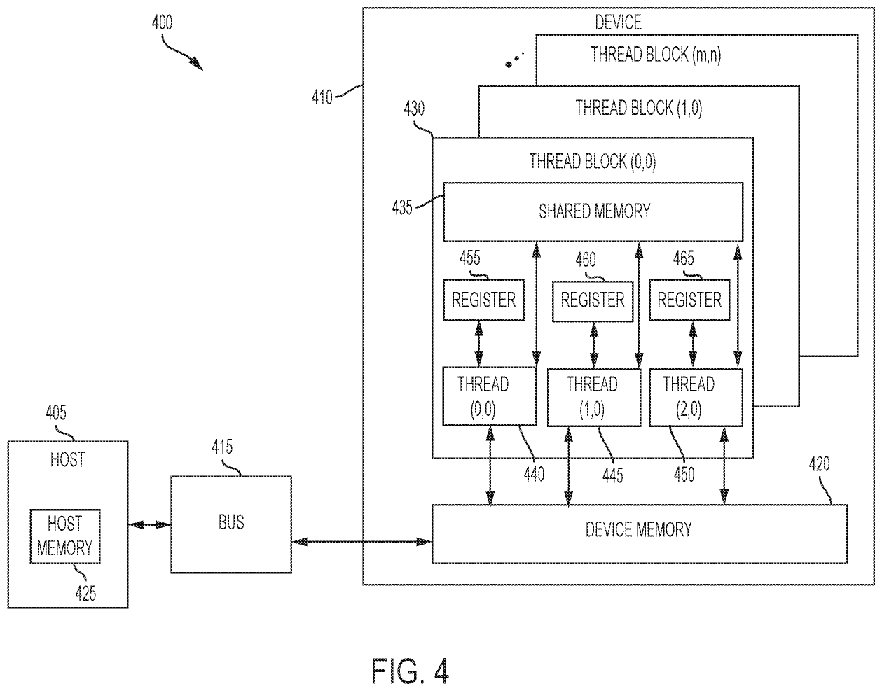

After step 210, there is a segmentation of the data based on time. That is, the state at different time periods is known. At step 215, for each component i, each xₜ assigned to i is identified and used to train a Gaussian process. Conceptually, this may be understood as concatenating the data from all of the states. For example, if the component i indicates that a machine is in a “sleeping” state between the hours of 9 am-10 am and 1 pm to 2 pm, the corresponding sensor values are concatenated to provide two hours of “sleeping” sensor data. This is repeated for every component/state. Thus, for every component (i.e., every state) a single, non-linear model is learned. Using this process, w and σ_{d} are obtained where d=1, 2, . . . , D. In some embodiments, each component i can be processed independently in parallel using a computing platform such as illustrated below in FIG. 4.

Then, at step 220, with the Gaussian process fixed, the EM algorithm is applied to re-estimate pᵢ, mᵢ, Cᵢ, Z, where i=1, 2, . . . , K. Recall that in step 205, a SSAR model is used to obtain initial estimates for pᵢ, mᵢ, Cᵢ, and Z. In step 220, the accuracy of this initial prediction is enhanced through re-estimation. Following step 220, there is a check to see if the algorithm has converged. This may be performed by determining the difference between the values of pᵢ, mᵢ, Cᵢ, Z and their corresponding values from a prior iteration of the process 200. If the difference is below a predetermined value, then process finishes. This predetermined value can be set based on the type and granularity of the underlying data so, for example, values of 0.1, 0.01, or 0.001 may be used. Otherwise, steps 210-220 are repeated until convergence.

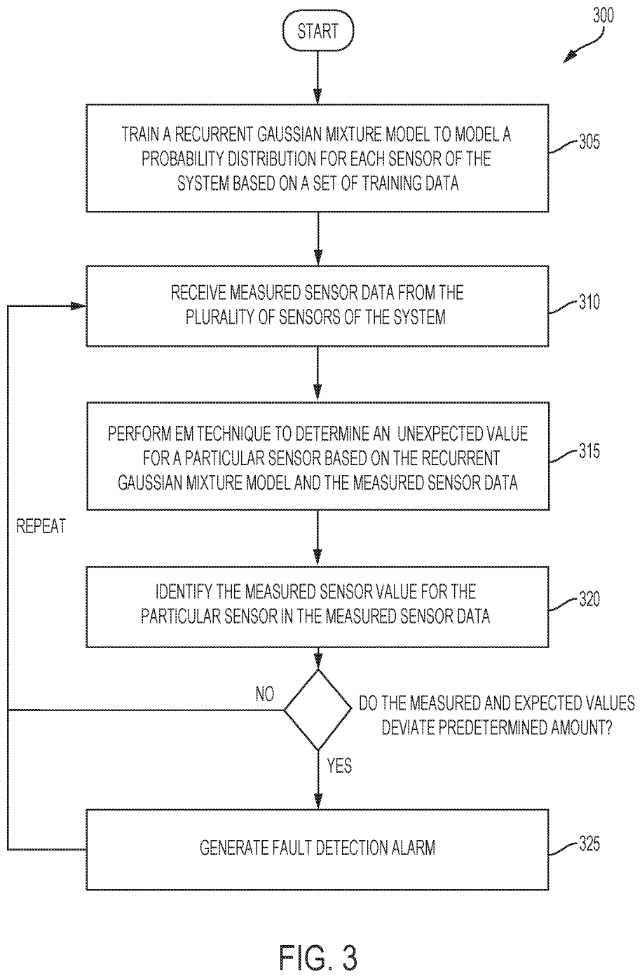

FIG. 3 illustrates a method 300 for performing machine condition monitoring using sensor data, according to some embodiments of the present invention. Briefly, P(xₜ|yₜ) is computed and the noise variance θ is estimated simultaneously using another EM algorithm. The task of condition monitoring is to detect faults at an early stage to avoid damages to the machine. When a machine is working properly, the sensor data should be distributed in a normal operating range. However, when future sensor data deviates from this range, there may be a fault. Thus, the method 300 ultimately is used to detect faults so that they can be addressed by machine operators or other persons that can assist in addressing fault issues.

The method 300 shown in FIG. 3 is intended to be implemented using one or more computers. For example, in an automation context, the method 300 may be implemented on a controller device or another computer in the production environment. If the architecture includes a parallel processing platform, the speed of the operations associated with the method 300 may be increased using parallelization techniques generally known in the art. This is described in more detail below with respect to FIG. 4.

Starting at step 305, a recurrent Gaussian mixture model is trained to model a probability distribution for each sensor of the system based on a set of training data. This training may take place generally as described above with respect to FIG. 2. The trained recurrent Gaussian mixture model applies a Gaussian process to each sensor dimension to estimate current sensor values based on previous sensor values. In some embodiments, the set of training data comprises sensor data from the plurality of sensors recorded during a period of fault-free operation of the system. As noted above, the recurrent Gaussian mixture model utilizes a plurality of mixture components and each component follows a Markov chain from a previous corresponding component. In some embodiments, each mixture component corresponds to one of a plurality of machines states associated with the system (e.g., a sleeping state, a stand-by state, a running state, etc.).

At step 310, the computing system receives measured sensor data from the plurality of sensors of the system. Where the system is directly connected to the sensors (e.g., in the controller context), the sensor values may be received directly. However, it should be noted that the method 300 may alternatively be implemented using a computer not directly connected to the sensors. For example, a controller or other computing device can pass data to the computing system over a network to perform conditioning monitoring, and possibly other monitoring tasks.

At step 315, an EM technique is performed to determine an expected value for a particular sensor based on the recurrent Gaussian mixture model and the measured sensor data. That is, the EM algorithm is applied to compute P(xₜ|yₜ). Additionally, noise variance θ may be estimated simultaneously. With the estimated value determined, at step 320, the measured sensor value for the particular sensor in the measured sensor data is identified in the data that was received at step 310. The measured and estimated values are then compared.

If the values deviate by more than a predetermined amount, a fault detection alarm is generated at step 325 indicating that the system is not operating within a normal operating range. The exact value of the predetermined amount may be preset by the system operator and may depend on the type of data. For example, consider a gas pressure sensor providing readings in kilopascals (kPa). A deviation of 100 pascals (Pa) may be ignored, while a deviation of 1 or more kPa may trigger the alarm. Various techniques may be used for producing the alarm. For example, in some embodiments, the fault detection alarm comprises an audible alarm generated by a speaker associated with the system (e.g., a speaker on a human-machine-interface computer within an automation system). In other embodiments, the fault detection alarm comprises a visual alarm presented on a display associated with the system (e.g., a computer monitor connected to a human-machine-interface computer within an automation system).

To illustrate the benefit of the techniques described herein, GMM and SSAR were compared using a real data set with 6 sensors. Artificial deviation was added to one sensor to simulate faults. Part of the data was used without deviation to train all models and test on the remaining part with deviation. The mean absolute error (MAE) was used for evaluating performance on test data. In addition, the following errors were investigated in different aspects of the data: MAE of all sensors during normal time (Eₙ), MAE of faulty sensors during faulty time (E_{ff}) and MAE of normal sensors during faulty time (E_{nf}).

Table 1 shows the error scores for different algorithms. The RGMM described herein produces lowest errors. SSAR produces worse results on this dataset. There can be two reasons for this. First, temporal dependency in this case is nonlinear. Second, SSAR overfits the data (sensors are highly correlated).

TABLE 1
MAE scores for different algorithms

| Algorithm | GMM | SSAR | RGMM |
|---|---|---|---|
| Eₙ | 0.063 | 0.230 | 0.032 |
| E_{ff} | 0.143 | 0.171 | 0.102 |
| E_{nf} | 0.119 | 0.203 | 0.020 |

FIG. 4 provides an example of a parallel processing memory architecture 400 that may be utilized to perform computations related to model training and/or condition monitoring, according to some embodiments of the present invention. This architecture 400 may be used in embodiments of the present invention where NVIDIA™ CUDA (or a similar parallel computing platform) is used. The architecture includes a host computing unit (“host”) 405 and a GPU device (“device”) 410 connected via a bus 415 (e.g., a PCIe bus). The host 405 includes the central processing unit, or “CPU” (not shown in FIG. 4) and host memory 425 accessible to the CPU. The device 410 includes the graphics processing unit (GPU) and its associated memory 420, referred to herein as device memory. The device memory 420 may include various types of memory, each optimized for different memory usages. For example, in some embodiments, the device memory includes global memory, constant memory, and texture memory.

Parallel portions of a deep learning application may be executed on the architecture 400 as “device kernels” or simply “kernels.” A kernel comprises parameterized code configured to perform a particular function. The parallel computing platform is configured to execute these kernels in an optimal manner across the architecture 400 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by grid of thread blocks (described in greater detail below). Using concurrent kernel execution, streams, and synchronization with lightweight events, the architecture 400 of FIG. 4 (or similar architectures) may be used to parallelize training of a deep neural network. For example, in some embodiments, the training dataset is partitioned such that the data from each component (e.g., each machine state) is processed in parallel.

The device 410 includes one or more thread blocks 430 which represent the computation unit of the device 410. The term thread block refers to a group of threads that can cooperate via shared memory and synchronize their execution to coordinate memory accesses. For example, in FIG. 4, threads 440, 445 and 450 operate in thread block 430 and access shared memory 435. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 4, the thread blocks 430 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints. In some embodiments, processing of subsets of the training data may be partitioned over thread blocks automatically by the parallel computing platform software. However, in other embodiments, the individual thread blocks can be selected and configured to optimize training of the RGMM. For example, in one embodiment, each thread block is a particular component or set of components with overlapping values.

Continuing with reference to FIG. 4, registers 455, 460, and 465 represent the fast memory available to thread block 430. Each register is only accessible by a single thread. Thus, for example, register 455 may only be accessed by thread 440. Conversely, shared memory is allocated per thread block, so all threads in the block have access to the same shared memory. Thus, shared memory 435 is designed to be accessed, in parallel, by each thread 440, 445, and 450 in thread block 430. Threads can access data in shared memory 435 loaded from device memory 420 by other threads within the same thread block (e.g., thread block 430). The device memory 420 is accessed by all blocks of the grid and may be implemented using, for example, Dynamic Random-Access Memory (DRAM).

Each thread can have one or more levels of memory access. For example, in the architecture 400 of FIG. 4, each thread may have three levels of memory access. First, each thread 440, 445, 450, can read and write to its corresponding registers 455, 460, and 465. Registers provide the fastest memory access to threads because there are no synchronization issues and the register is generally located close to a multiprocessor executing the thread. Second, each thread 440, 445, 450 in thread block 430, may read and write data to the shared memory 435 corresponding to that block 430. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 410 to read and/or write to the device memory. Device memory requires the longest time to access because access must be synchronized across the thread blocks operating on the device. Thus, in some embodiments, the processing of each component is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 4, standard computing platforms (e.g., servers, desktop computer, etc.) may be specifically configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method for monitoring a system, comprising:
training a recurrent Gaussian mixture model to model a probability distribution for each sensor of the system from among a plurality of sensors of the system based on a set of training data, wherein the recurrent Gaussian mixture model applies a Gaussian process to each sensor dimension to estimate current sensor values based on previous sensor values;
receiving measured sensor data from the plurality of sensors of the system;
performing an expectation-maximization technique to determine an expected value for a particular sensor based on the recurrent Gaussian mixture model and the measured sensor data;
identifying a measured sensor value for the particular sensor in the measured sensor data; and
if the measured sensor value and the expected sensor value deviate by more than a predetermined amount, generating a fault detection alarm indicating that the system is not operating within a normal operating range.

2. The method of claim 1, wherein the recurrent Gaussian mixture model utilizes a plurality of mixture components and each component follows a Markov chain from a previous corresponding component.

3. The method of claim 2, wherein each mixture component corresponds one of a plurality of machines states.

4. The method of claim 3, wherein the plurality of machine states comprise a sleeping state, a stand-by state, and a running state.

5. The method of claim 1, wherein the fault detection alarm comprises an audible alarm generated by a speaker associated with the system.

6. The method of claim 1, wherein the fault detection alarm comprises a visual alarm presented on a display associated with the system.

7. The method of claim 1, wherein the set of training data comprises sensor data from the plurality of sensors recorded during a period of fault-free operation of the system.

8. The method of claim 1, wherein training the recurrent Gaussian mixture model comprises:
training a stationary switching autoregressive model to obtain initial estimates for parameters comprising (a) a component probability; (b) a mean value for a Gaussian distribution of expected sensor values; (c) covariance for the Gaussian distribution of expected sensor values; and (d) a component transition probability matrix;
iteratively perform a re-estimation process until convergence of one or more of the parameters, wherein the re-estimation process comprises:
assigning each sensor value in the set of training data to one of the plurality of components in the component transition probability matrix based on the component probability;
for each component, using the sensor values assigned to the component to train the Gaussian process corresponding to the component;
for each component, performing an expectation-maximization technique to re-estimate the parameters for the component based on the Gaussian process corresponding to the component.

9. The method of claim 8, wherein the sensor value is assigned to the one of the plurality of components in the component transition matrix by making a hard decision.

10. The method of claim 9, wherein each component corresponds to one of a plurality of machines states.

11. A computer-implemented method for monitoring a system, comprising:
performing a training process to train a recurrent Gaussian mixture model based on a set of training data to use a Gaussian process to estimate sensor values based on previous sensor values, wherein the training process comprises:
training a stationary switching autoregressive model to obtain initial estimates for parameters comprising (a) a component probability; (b) a mean value for a Gaussian distribution of expected sensor values; (c) covariance for the Gaussian distribution of expected sensor values; and (d) a component transition probability matrix;
iteratively perform a re-estimation process until convergence of one or more of the parameters, wherein the re-estimation process comprises:
assigning each sensor value in the set of training data to one of the plurality of components in the component transition probability matrix based on the component probability;
for each component, using the sensor values assigned to the component to train the Gaussian process corresponding to the component;
for each component, performing an expectation-maximization technique to re-estimate the parameters for the component based on the Gaussian process corresponding to the component;
receiving measured sensor data from the plurality of sensors of the system;
determining an expected value for a particular sensor based on the recurrent Gaussian mixture model and the measured sensor data;
identifying a measured sensor value for the particular sensor in the measured sensor data;
if the measured sensor value and the expected sensor value deviate by more than a predetermined amount, generating a fault detection alarm indicating that the system is not operating within a normal operating range.

12. The method of claim 11, wherein a plurality of processors are used to train the Gaussian process for multiple components in parallel.

13. The method of claim 11, wherein a plurality of processors are used to perform the expectation-maximization technique for multiple components in parallel.

14. The method of claim 11, wherein the recurrent Gaussian mixture model utilizes a plurality of mixture components and each component follows a Markov chain from a previous corresponding component.

15. The method of claim 14, wherein each mixture component corresponds one of a plurality of machines states.

16. The method of claim 11, wherein the fault detection alarm comprises an audible alarm generated by a speaker associated with the system.

17. The method of claim 11, wherein the fault detection alarm comprises a visual alarm presented on a display associated with the system.

18. The method of claim 11, wherein the set of training data comprises sensor data from the plurality of sensors recorded during a period of fault-free operation of the system.

19. A system for monitoring a machine, the system comprising:
a plurality of sensors collecting measured sensor data associated with the machine; and
one or more processors configured to:
perform an expectation-maximization technique to determine an expected value for a particular sensor based on a recurrent Gaussian mixture model and the measured sensor data, wherein (a) the recurrent Gaussian mixture model is trained to model a probability distribution for each sensor of the plurality of sensors based on a set of training data and (b) the recurrent Gaussian mixture model applies a Gaussian process to each sensor dimension to estimate current sensor values based on previous sensor values;
identify a measured sensor value for the particular sensor in the measured sensor data; and
if the measured sensor value and the expected sensor value deviate by more than a predetermined amount, generate a fault detection alarm indicating that the system is not operating within a normal operating range.
